(19) United States
(12) Patent Application Publication
(10) Pub. No.: US 2005/0184505 A1
(43) Pub. Date: Aug. 25, 2005

(54) Multi-panel in-mold label

(75) Inventor: Albert R. Barlow, Union, KY (US)

Correspondence Address: Stephen B. Salai, Esq.;Harter, Secrest & Emery LLP, 1600 Bausch & Lomb Place, Rochester, NY, 14604-2711, US

(73) Assignee: WS Packaging Group, Inc., Algoma, WI (US)

(21) Appl. No.: 10/785,523

(22) Filed: Feb. 24, 2004

(51) Int. Cl. B42D 15/00

(52) U.S. Cl. 283/81

(57) ABSTRACT

An in-mold label is formed with multiple panels that significantly increase the printable area of the labels. For example, such multi-panel labels can include a base panel and an overlying panel. A pressure-sensitive adhesive layer temporarily bonds the base and overlying panels and a heat-activated adhesive layer permanently bonds the base layer to a wall of the container. The heat-activated adhesive can be activated by exposure to molten material during the molding process. The adhesive characteristics of the pressure-sensitive adhesive are not adversely affected by transmissions of heat from the molten material through the base panel.

### BACKGROUND OF THE INVENTION

1. Field of the Invention

The invention relates to printed labels that are integrally molded into the walls of molded products or containers and to such products or containers having integrally molded printed labels.

2. Description of Related Art

Government regulations, market demands, and industry standards mandate that the printing of an increasing amount of information on products or their containers. Labels are often used to supply this information. However, for aesthetic or other reasons, including the size of the products or their containers, the size of the labels together with the space available for printing desired graphics or other information is limited.

Such limitations are particularly evident with in-mold labels that are integrally molded into the walls of the products or containers. Individual printed labels are mounted within a product or container mold and are exposed to molten material that forms the product or container within the mold. A back surface of the label is coated with an adhesive that is activated by the elevated temperature of the molten material to which the adhesive is exposed. When the adhesive cools along with the molten material, the label is permanently bonded to the product or container.

Generally, the in-mold labels are molded within corresponding recesses in the exterior surfaces of the products or containers so that the labels are mounted flush with the exterior surfaces. The recesses protect the edges of the labels and present an appealing appearance. However, such recess mountings also tend to limit the size of the labels for both structural and aesthetic reasons.

### BRIEF SUMMARY OF THE INVENTION

My invention increases the space available for printing graphics or other information on in-mold labels by incorporating multiple panels into the labels. In addition to a base panel, which can be bonded via the molding process to a molded product or container, the invention features one or more overlying panels that can be temporarily bonded to the base panel to provide additional surfaces onto which graphics or other information can be printed. The new multi-panel in-mold labels allow manufacturers to double or more the available space for printing, while preserving the overall intended appearance of conventional in-mold labels.

One example of an in-mold multi-panel label in accordance with my invention includes a base panel and an overlying panel, each having front and back surfaces. A first adhesive layer is located adjacent to the back surface of the base panel, and a second adhesive layer is located between the front surface of the base panel and the back surface of the overlying panel. Graphics or other information is printed on the front surface of at least the overlying panel. The first adhesive layer includes a heat-activated adhesive for adhering the base panel to a product or container in response to the exposure of the base panel to elevated temperature of molten material within the mold. The second adhesive layer has desired adhesive characteristics that are not adversely affected by transmissions of heat from the molten material through the base panel.

A release layer can also be located between the front surface of the base panel and the back surface of the overlying panel. The release layer can be patterned so that the second adhesive layer forms a permanent bond between a first overlapping area located between the base and overlying panels and forms a temporary bond between a second overlapping area located between the base and overlying panels. The overlying panel has a periphery, and a first portion of the periphery is within the second overlapping area so that the overlying panel can be peeled away from the base panel for revealing graphics or other information printed on the front surface of the base panel. In addition, the overlying panel can be perforated within the second overlapping area so that the overlying panel can be separated along the perforation and peeled away from the base panel for revealing graphics or other information printed on the front surface of the base panel.

Preferably, the release layer is carried on the front surface of the base panel and the second adhesive layer is carried on the back surface of the overlying panel. An adhesive deadening agent can be applied to portions of the second adhesive area adjacent to the periphery of the overlying panel so that the overlying panel can be more readily peeled away from the base panel.

The overlying panel can be a first of a plurality of overlying panels that are temporarily bonded to each other. Each panel provides more space for printing graphics or other information. Intermediate layers of adhesive can temporarily bond the plurality of overlying panels to each other. Intermediate layers of release can be used to allow the overlying panels to be partially or completely separated from each other. The overlying panels can be formed from separate substrates or from a single folded substrate.

Preferably, the second adhesive layer is a pressure-sensitive adhesive formed by an acrylic emulsion. The base panel can be made of a resin film, but paper is expected to work as well or better. The overlying panel can also be made of paper or film, but paper is preferred for many applications.

One example of a molded product or container having an integrally molded multi-panel label in accordance with my invention includes a multi-panel label integrally molded into a wall of the product or container. The multi-panel label includes a base panel and an overlying panel. Graphics or other information is printed on at least the overlying panel and preferably both panels. The base panel is permanently bonded to the wall within a recess formed by the multi-panel label within the wall during molding. The overlying panel is temporarily bonded to the base panel so that the overlying panel is partially or completely separable from the base panel to reveal the printed information on the base panel.

The overlying panel can have a front surface that is substantially flush with an exterior surface of the wall. However, a finger well can be formed in a portion of the exterior surface to expose a limited portion of the overlying panel's periphery. Alternatively, the multi-panel label can be mounted in a mold recess, whose depth can be set to expose the entire periphery of one or more of the panels.

An adhesive layer is preferably located between the overlying and base panels to temporarily bond the overlying and base panels together. The adhesive characteristics of the adhesive layer are not adversely affected by transmissions of heat from the molten material that forms the wall of the product or container.

The multi-panel label also preferably includes a release layer also located between the base and overlying panels. The release layer can be patterned so that that the pressure-sensitive adhesive layer forms a permanent bond between a first overlapping area located between the base and overlying panels and forms a temporary bond between a second overlapping area located between the base and overlying panels. A first portion of the overlying panel's periphery is located within the second overlapping area so that the overlying panel can be peeled away from the base panel for revealing graphics or other information printed on the base panel. The pressure-sensitive adhesive layer preferably remains sufficiently tacky even after the overlying panel has been peeled away so that the overlying panel can be resealed to the base panel by the pressure-sensitive adhesive layer.

The overlying panel is preferably a first of a plurality of overlying panels that are temporarily bonded to each other. The plurality of overlying panels can be formed from separate substrates or from a single folded substrate.

The overlying panel is preferably sized to match the base panel so that both can be easily die cut from the same processed label stock. However, the overlying panel could also be made smaller than the base panel, such as by limited depth die-cutting, for facilitating its partial or complete removal from the base panel. Regardless of its relative size in relation to the base panel, the overlying panel is preferably partially or completely removable for viewing information on either or both of its back surface and the front surface of the base panel.

The additional printing space permits more information to be carried by in-mold labels without taking up more space on the molded product or container exteriors. The overlying panels can also be made removable or reversible to allow a reordering of the information presented by the panels. For example, information can be printed in different languages on respective surfaces of the overlying panels, and the respective surfaces can be reordered to present a selected language more prominently. Coupons, rebates, game pieces, and other print media forms can also be incorporated into the multiple panel design.

### BRIEF DESCRIPTION OF THE SEVERAL VIEWS OF THE DRAWING(S)

FIG. 1 is a front view of a molded container having an integrally molded multi-panel label.

FIG. 2 is an enlarged cut-away cross-sectional view of the multi-panel label mounted within a recess of the molded container.

FIG. 3 is another front view of the molded container showing an overlying panel of the multi-panel label partially retracted for revealing information printed on an underlying panel layer.

FIG. 4 is a diagram of an in-line printing system for making the multi-panel labels.

FIG. 5 is a cross-sectional view of a mold for forming the container having a vacuum mount area for temporarily holding the multi-panel label in place during the molding process.

FIG. 6 is a an enlarged cut-away cross-sectional view of a multi-panel label having a base panel and two overlying labels that can be peeled open from opposite directions.

FIG. 7 is an enlarged cut-away cross-sectional view of another multi-panel label having a smaller second overlying panel that can be completely removed.

FIG. 8 is a an enlarged cut-away cross-sectional view of another multi-panel label having a line of perforation for opening an overlying panel from opposite sides of the line of perforation.

### DETAILED DESCRIPTION OF THE INVENTION

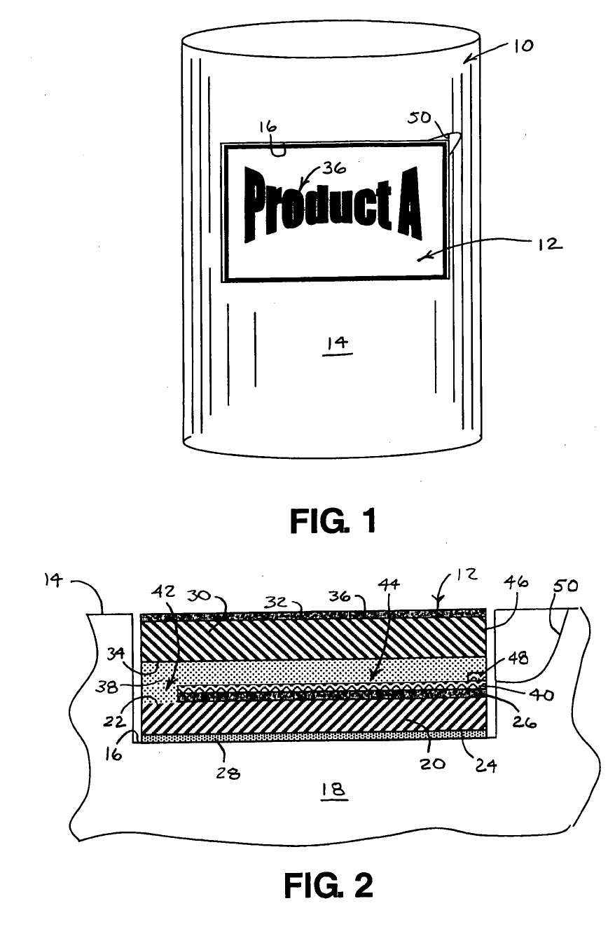

A molded container 10 in which a multi-panel label 12 is molded into an exterior surface 14 of the container 10 is depicted by FIGS. 1-3. The multi-panel label 12 is molded within a recess 16 of its own making flush with a surface 14 of the container 10. It is the multi-panel label 12 themselves that displaces molten material during the molding process for mounting the multi-panel label in a wall 18 of the container 10.

The multi-panel label 12 is assembled from a base panel 20 and an overlying panel 30. The base panel 20 has a front surface 22 supporting a print layer 26 of graphics or other information and a back surface 24 that is coated with a heat-activated adhesive layer 28. The overlying panel 30 has a front face 32 supporting another print layer 36 of graphics or other information and a back surface 34 that is coated with a pressure-sensitive adhesive layer 38. Between the adhesive layer 38 on the back surface 34 of the overlying panel 30 and the print layer 26 on the front surface 22 of the base panel 20 or the front surface 22 itself is a release layer 40 that is formulated in cooperation with the pressure-sensitive adhesive layer 38 to provide a releasable or temporary bond between the base and overlying panels 20 and 30. Another print layer (not shown) can be supported on the back surface 34 of the overlying panel 30 above or below the adhesive layer 38 to exploit an additional area for presenting graphics or other information.

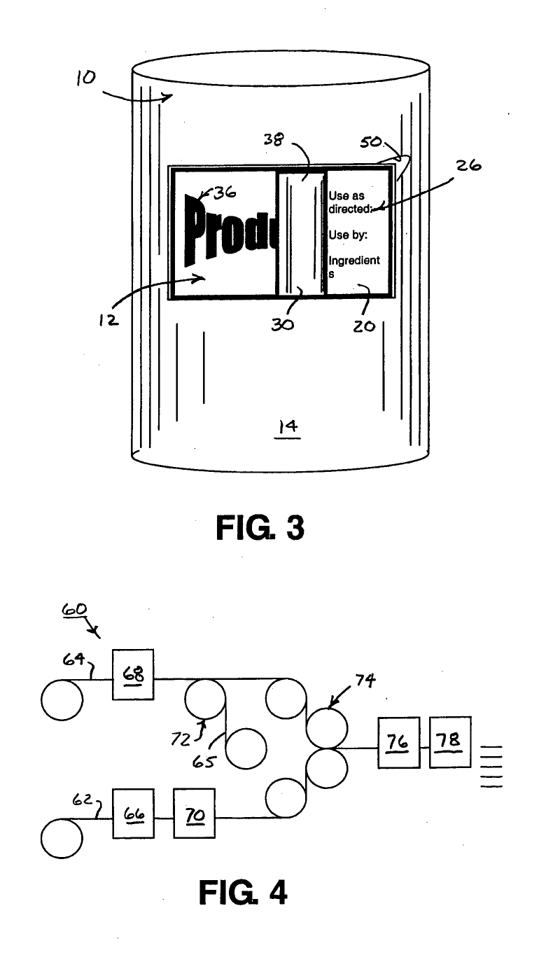

In the example shown, the release layer 40 is patterned so that the pressure-sensitive adhesive layer 38 forms a permanent bond within a first overlapping area 42 between the base panel 20 the overlying panel 30 (i.e., the area devoid of the print layer 26), and forms a temporary bond within a second overlapping area 44 between the base panel 20 and the overlying panel 30 (i.e., the area covered by the print layer 26). The overlying panel 30 has a periphery 46, and a portion of the periphery 46 is within the second overlapping area 44. Starting at the indicated portion of periphery 46, the overlying panel 30 can be peeled away from the base panel 20 within the second overlapping area 44 as shown in FIG. 3 for revealing the underlying print layer 26 of graphics or other information on the front surface 22 of the base panel 20. Another patterned area of release 48 can be printed on the adhesive layer 38, along a portion of the periphery 46 and preferably in a corner of the multi-panel label 12, to deaden local adhesive characteristics of the pressure-sensitive adhesive layer 38 for assisting in the initial separation of the overlying panel 30 from the base panel 20. A corresponding finger well 50 can be molded into the container 10 to provide a better access to a corner of the label periphery 46.

The overlying panel 30 can be peeled apart from the base panel 20, as shown in FIG. 3 and retracted until the overlying panel 30 encounters the first overlapping area 42 at which the pressure-sensitive adhesive 38 makes a permanent bond between the base panel 20 and the overlying panel 30. Thus, the overlying panel 30 is retractable but not entirely removable.

Preferably, the pressure-sensitive adhesive layer 38 remains tacky so that the overlying panel 30 can be laid back in place within the second overlapping area 44 to restore the original appearance of the multi-panel label 12. Alternatively, the overlying panel 30 could be made completely removable from the base panel 20 by providing an uninterrupted layer of release between the two panels 20 and 30. The bonding performance of the adhesive layer 38 could also be modified so that once removed, the overlying panel 30 cannot be re-affixed to the base panel 20.

The multi-panel labels 12 can be assembled along an in-line press 60 such as shown in FIG. 4. The base panel 20 is formed, together with the heat-activated adhesive layer 28, from a web 62 that includes a paper or film substrate pre-coated with a heat-activated adhesive. Examples of such web stocks are available from Avery Dennison and sold as #72854 FasClear film, #72855 Primax film, and #76648 Kimdura film. The overlying panel 30 is formed, together with the pressure-sensitive adhesive layer 38, from a web 64 of conventional pressure-sensitive label stock. The web 64 of conventional label stock includes a paper or film substrate pre-coated with a pressure-sensitive adhesive and mounted on a release liner 65.

A face of the web 62 is printed at a print station 66 to form the print layer 26 of graphics or other information. Similarly, a face of the web 64 is printed at a print station 68 to form the print layer 36. In accordance with conventional practices, the print stations 66 and 68 can represent banks of print stations for printing in multiple color inks or layers. A pattern coater 70 applies the release layer 40 on the web 62 in a desired pattern for defining the intended first and second overlapping areas 42 and 44 between the base panel 20 and the overlying panel 30. Just prior to a laminating station 74 that subsequently joins the two webs 62 and 64 together, a delaminating station 72 removes and rewinds the release liner 65 of the web 64. Removal of the release liner 65 exposes the pressure-sensitive adhesive coating for bonding the remaining portion of the web 64 together with the web 62. During the pressure-sensitive adhesive's temporary exposure, another pattern coater (not shown) can apply the pattern of release 48 to deaden selected portions of the pressure-sensitive adhesive or a print station (not shown) could apply another print layer over the exposed adhesive.

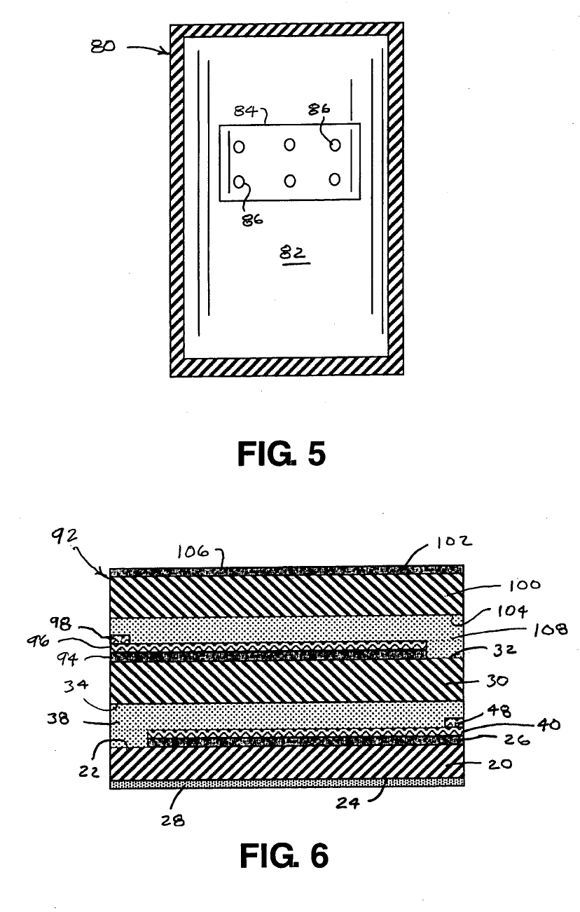

A die-cut station 76 divides the combined web 62, 64 into the individual multi-panel labels 12, and a stacker 78 arranges the individual labels 12 into stacks from which the labels 12 can later be drawn for mounting into product or container molds, such as the mold 80 shown in FIG. 5.

The mold 80 has an interior wall 82 intended for forming the exterior surface 14 of the container 10. On the interior wall 82 is a vacuum label mount area 84. The multi-panel labels 12 are individually drawn from a stack such as by the operation of a robot arm (not shown). Arms of this sort are known to include one or more vacuum drawn cups for lifting individual labels from stacks and drives for moving the individual labels in place within molds, such as against the label mount area 84. Once in position, vacuum drawing pins 86 provide for holding the multi-panel labels 12 in place during the molding process. The vacuum mount area 84 can be flush with the interior wall 82 for resulting in a label mount similar to that shown in FIG. 2 or can be recessed to expose the peripheries of one or more of the panels (e.g., 20 or 30) above the molded surface 14 of the container 10. The vacuum mount area 84 could also project above the interior wall 82 to recess the multi-panel labels 12 beneath the container surface 14.

The labels 12 are mounted so that the heat-activated adhesive layer 28 is exposed within the mold 80. A molten material such as resin is pressed against the interior wall 82 of the mold to incorporate the multi-panel label 12 within the exterior surface 14 of the container 10. For mounting the print layer 36 flush with the container surface 14, the multi-panel label 12 is drawn against the same interior wall 82, and the multi-panel label's limited volume displaces molten material around the label to form the recess 16 shown in FIG. 1.

The heat-activated adhesive 28 is of a type that is activated by the elevated temperatures of the molten material that forms the wall 18 of container 10. When the wall 18 cools, the heat-activated adhesive 28 forms a permanent bond with the wall 18. A variety of molding processes can be used for this purpose including blow molding, injection molding, roto-molding, compression molding, or thermoforming.

In one envisioned molding process, a blow-molded resin parison reaches a mold temperature of between 350 and 400 degrees Fahrenheit. However, the mold itself is chilled to between 50 and 80 degrees Fahrenheit. A temperature differential is realized across the multi-panel label 12. The heat-activated adhesive 28 is activated at an intermediate temperature of approximately 180-220 degrees Fahrenheit. Exposure of the heat-activated adhesive 28 to the molten parison assures that the threshold activating temperature of the adhesive is reached.

The pressure-sensitive adhesive 38 is preferably an acrylic emulsion that is not damaged by exposure to the heat of the molding process. Such emulsions are sufficiently elastic to expand and contract with temperature changes affecting the adhesives as well as their adjoining substrates without harming their intended adhesive characteristics. One such pressure-sensitive adhesive is an all-temperature acrylic emulsion available from Fasson Roll North America (A division of Avery Dennison) as a product code AT20.

The base panel 20 can be made of paper or film. For example, the base panel 20 can be an olefin material made from clear and white polyolefins having a thickness in the range of approximately 0.004 through 0.008 inches. The heat-activated adhesive layer 28 is preferably pre-coated onto the base panel 20. The overlying panel 30 can also be made of paper or film but is preferably made of paper so that the multi-panel label 12 can be made from conventional paper label stock, which includes the pressure-sensitive adhesive layer 38. Both substrates are selected of materials that can accommodate temporary distortions caused by temperature fluctuations within the mold 80.

FIGS. 6-8 show alternative multi-panel labels 92, 112, and 132, each having a different arrangement of panels for displaying multiple layers of graphics or other information and for providing additional functionality. However, for parts in common between the multi-panel label 12 and the alternative multi-panel labels 92, 112, and 132, the same reference numerals as those used in FIG. 2 are applied.

For example, all three of the alternative multi-panel displays 92, 112, and 132 share the same base panel 24 coated with the heat-activated adhesive layer 28. The alternative multi-panel labels 92 and 112 also share the same overlying panel 30 together with the intervening layers of print 26, release 40, and pressure-sensitive adhesive 38.

However, the multi-panel label 92 of FIG. 6 also includes an overlying face panel 100 having a front surface 102 supporting a print layer 106 of graphics or other information and a back surface 104 that is coated with a layer 108 of pressure-sensitive adhesive. Between the two overlying panels 30 and 100, a release pattern 98 deadens an edge of the pressure-sensitive adhesive layer 108, and layers of print 94 and release 98 are patterned on the intermediate overlying panel 30 with mirror symmetry to corresponding layers 48, 40, and 26 between the overlying panel 30 and the base panel 20.

The overlying face panel 100 can be peeled back in one direction, and the overlying intermediate panel 30 can be peeled back in an opposite direction. The arrangement allows the overlying panels 100 and 30 to be sequentially retracted in a fan-fold configuration for revealing the graphics or other information contained in the underlying print layers 94 and 26 and to be restored to their initial temporarily bonded condition. Although shown as separate panels, it would be possible to construct a similar configuration of panels by folding a single substrate. Only temporary adhesive bonds would be required between the folded layers because the layers would be otherwise connected to each other.

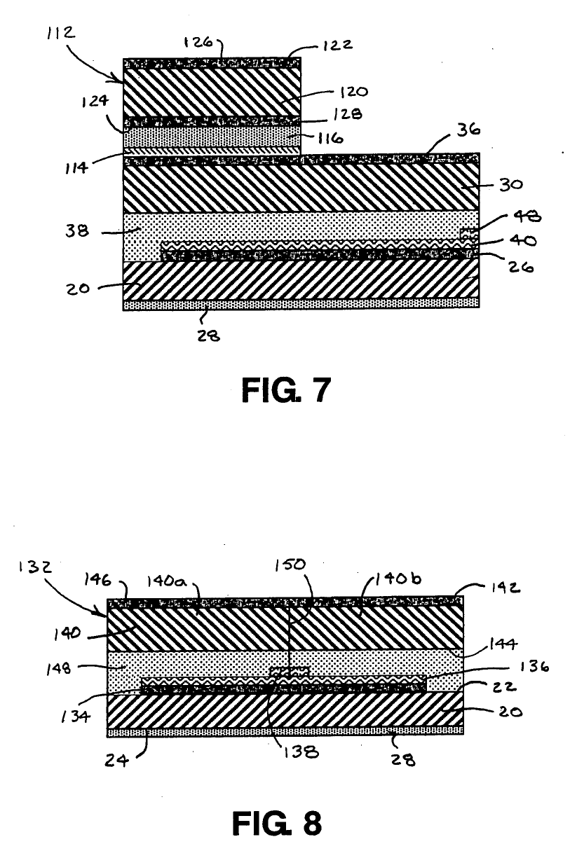

The alternative multi-panel label 112 of FIG. 7 includes a removable overlying panel 120 appended to the label construction of FIG. 2. The removable overlying panel 120 is sized to overlap only a portion of the print layer 36 on the panel 30, but could also be sized the same. Print layers 126 and 128 are applied to the front and back surfaces 122 and 124 of the removable panel 120. A clear base 114 is applied to at least a portion of the print layer 36 of the overlying panel 30, and a dry release adhesive layer 116 is applied to the print layer 128 of the removable panel 120. The dry release adhesive layer 116 bonds the removable overlying panel 120 to the intermediate overlying panel 30. However the dry release adhesive layer 116 together with the clear base 114 allows the removable panel 120 to be permanently removed with little or no adhesive residue active on either panel 120 or 30.

Ordinarily, such dry release adhesives are relatively intolerant of the expansions and contractions that accompany significant temperature changes. However, the multiple intervening panels 20 and 30 provide insulating properties, and the removable panel 120 can be recessed within a chilled mold cavity for further moderation of temperature variation. Such removable panels, such as the removable panel 120 are especially suitable as coupons.

The alternative multi-panel label 132 shown in FIG. 8 is a modified two-panel design. An overlying panel 140 has a print layer 146 on a front surface 142 and a pressure-sensitive adhesive layer 148 on a back surface 144. Print and release layers 134 and 136 are applied to the base panel 20 in patterns that allow the pressure-sensitive adhesive layer 148 to form permanent bonds between the overlying panels 140 and the base panel 20 at opposite ends. A line of perforation 150 splits the overlying panel 140 into two halves 140a and 140b anchored by the permanent adhesive bonds at either end. Release patterns 138 deaden the pressure-sensitive adhesive 148 adjacent to the line of perforation, so that the two halves 140a and 140b can be more easily peeled apart from the base panel 20 for revealing the underlying graphics or other information of the print layer 134. Alternatively, one or more lines of perforation could be used to allow the complete removal of a portion of the overlying panel 140.

Although described with respect to a limited number of embodiment, many more variations and combinations are possible in accordance with the teaching of the invention. For example, it would be possible to make an overlying panel completely removable from a base or another overlying panel, while still restorable to its initially bonded position. Repositionable adhesive can be removed with the removable panel or can remain with the overlying or base panels from which the removable panel was removed. Such removable panels can also be made reversible for reordering print layers on opposite sides of the removable panels (e.g., English printed on one side and Spanish printed on an opposite side). In addition to increasing or reordering printable areas, the multi-panel labels can also incorporate other structures, such as game pieces or security devices, to perform additional functions.

1. An in-mold multi-panel label comprising:
a base panel having front and back surfaces;
an overlying panel having front and back surfaces;
a first adhesive layer adjacent to the back surface of the base panel;
a second adhesive layer located between the front surface of the base panel and the back surface of the overlying panel;
graphics or other information printed on the front surface of at least the overlying panel of the base and overlying panels;
the first adhesive layer including a heat-activated adhesive for adhering the base panel to a product or container in response to the exposure of the base panel to elevated temperature of molten material within the mold; and
the second adhesive layer having desired adhesive characteristics that are not adversely affected by transmissions of heat from the molten material through the base panel.

2. The label of claim 1 in which a release layer is also located between the front surface of the base panel and the back surface of the overlying panel.

3. The label of claim 2 in which the release layer is patterned so that the second adhesive layer forms a permanent bond between a first overlapping area located between the base and overlying panels and forms a temporary bond between a second overlapping area located between the base and overlying panels.

4. The label of claim 3 in which the overlying panel has a periphery and a first portion of the periphery is within the second overlapping area so that the overlying panel can be peeled away from the base panel for revealing graphics or other information printed on the front surface of the base panel.

5. The label of claim 3 in which the overlying panel is perforated within the second overlapping area so that the overlying panel can be separated along the perforation and peeled away from the base panel for revealing graphics or other information printed on the front surface of the base panel

6. The label of claim 2 in which the release layer is carried on the front surface of the base panel and the second adhesive layer is carried on the back surface of the overlying panel.

7. The label of claim 6 in which the overlying panel has a periphery and an adhesive deadening agent is applied to portions of the second adhesive area adjacent to the periphery of the overlying panel so that the overlying panel can be more readily peeled away from the base panel.

8. The label of claim 1 in which the overlying panel is a first of a plurality of overlying panels that are temporarily bonded to each other.

9. The label of claim 8 in which the plurality of overlying panels are temporarily bonded to each other by intermediate layers of adhesive.

10. The label of claim 9 in which intermediate layers of release allow the overlying panels to be at least partially separated from each other.

11. The label of claim 8 in which the plurality of overlying panels formed from a folded substrate.

12. The label of claim 1 in which the second adhesive layer is a pressure-sensitive adhesive.

13. The label of claim 11 in which the second adhesive layer is an acrylic emulsion.

14. The label of claim 1 in which the base panel is made of a resin film and the overlying panel is made of paper.

15. The label of claim 14 in which the resin film has a thickness of at least 0.004 inches.

16. A molded product or container having an integrally molded multi-panel label comprising:
a multi-panel label integrally molded into a wall of the product or container, the multi-panel label comprising:
base and overlying panels having graphics or other information printed on at least the overlying panel of the base and overlying panels;
the base panel being permanently bonded to the wall within a recess formed by the multi-panel label within the wall during molding; and
the overlying panel being temporarily bonded to the base panel so that the overlying panel is at least partially separable from the base panel to reveal the printed information on the base panel.

17. The product or container of claim 16 in which the overlying panel has a front surface that is substantially flush with an exterior surface of the wall.

18. The product or container of claim 17 in which the overlying panel has a periphery, and a finger well is formed in a portion of the exterior surface of the wall to expose a limited portion of the overlying panel's periphery.

19. The product or container of claim 16 in which an adhesive layer between the overlying and base panels temporarily bonds the overlying and base panels together.

20. The product or container of claim 19 in which adhesive characteristics of the adhesive layer are not adversely affected by transmissions of heat from the molten material that forms the wall of the product or container.

21. The product or container of claim 20 in which the adhesive layer is a pressure-sensitive adhesive layer.

22. The product or container of claim 20 in which the adhesive layer is an acrylic emulsion.

23. The product or container of claim 21 in which the multi-panel label further comprises a release layer between the base and overlying panels.

24. The product or container of claim 23 in which the release layer is patterned so that that the pressure-sensitive adhesive layer forms a permanent bond between a first overlapping area located between the base and overlying panels and forms a temporary bond between a second overlapping area located between the base and overlying panels.

25. The product or container of claim 24 in which the overlying panel has a periphery and a first portion of the periphery is within the second overlapping area so that the overlying panel can be peeled away from the base panel for revealing graphics or other information printed on the base panel.

26. The product or container of claim 25 in which the pressure-sensitive adhesive layer remains sufficiently tacky even after the overlying panel has been peeled away so that the overlying panel can be resealed to the base panel within the second overlapping area by the pressure-sensitive adhesive layer.

27. The product or container of claim 16 in which the overlying panel is a first of a plurality of overlying panels that are temporarily bonded to each other.

28. The product or container of claim 27 in which the plurality of overlying panels formed from a folded substrate.
